(19) United States
(12) Patent Application Publication
(10) Pub. No.: US 2019/0128550 A1
(43) Pub. Date: May 2, 2019

(54) INTELLIGENT WIRELESS TEST AND BALANCE SYSTEM

(71) Applicant: Campos Engineering, Inc., Dallas, TX (US)

(72) Inventor: Joseph W. Campos, Dallas, TX (US)

(21) Appl. No.: 15/802,113

(22) Filed: Nov. 2, 2017

(51) Int. Cl. F24F 11/49; H04Q 9/00; G05B 15/02; F24F 11/56; F24F 11/63; F24F 11/84; F24F 11/89

(52) U.S. Cl. CPC F24F 11/49; H04Q 9/00; G05B 15/02; H04L 67/12; F24F 11/63; F24F 11/84; F24F 11/89; F24F 11/56

(57) ABSTRACT

Intelligent wireless test and flow balance system that has a wireless system with data inputs and physical outputs for automatic HVAC test and balance. A wireless physical output device for temporarily rotating air dampers or water valves is utilized to control the output of the air dampers or water valves. The flow and output node system is battery powered allowing for placement in remote locations. The system also includes a capture hood that utilizes magnets to hold itself while allowing data to be captured. An airflow measurement device that uses a pass-through measurement technique, this airflow measurement device may be placed within or outside the capture hood. A unique adapter allows an electric motor to be temporarily attached to a damper or valve shaft. A wireless node network that allows for one or more nodes, such as flow and output nodes to be connected in a hierarchical or mesh network.

### TECHNICAL FIELD

The present invention relates to heating, ventilating, and air conditioning (HVAC) system airflow and water flow testing and balancing, in general, and apparatus for performing intelligent wireless test and balance on HVAC systems.

### BACKGROUND OF THE INVENTION

Many indoor environments have a climate control system that can heat or cool an indoor space to meet the comfort demands of the occupants, referred to as heating, ventilating, and air conditioning (HVAC). HVAC systems range in size and complexity, and engineers typically design, specify and match the HVAC air or water system with the specific needs of the space at that moment in time; such as supplying conditioned air to a room to maintain a comfortable temperature for its occupants. Many systems consist of a piece of equipment that heats or cools air and moves the air with a fan through a system of ducts. The ducts connect to a few or many grilles, an installed opening in a ceiling typically made of metal, that directs the conditioned air evenly throughout the space it serves. Each grille may require a different amount of airflow; therefore, before a grille, a device called a damper, is opened, or closed to control the amount of airflow that can come out of the grille. Other systems consist of a piece of equipment that heats or cools a fluid and moves the fluid with a pump through a system of pipes. The pipes are typically above a ceiling and connect to a few or many coils, a device used to transfer heat between two fluids such as water and air. Each coil may require a different amount of fluid flow; therefore, before or after a coil, a valve is opened or closed to control the amount of fluid that can flow through the coil.

HVAC air and water systems require an initial testing phase to confirm that the installed system meets the specific requirements of the design. Tests can consist of measuring the amount of airflow or water flow to compare it with the amount specified by the engineer. When airflow or water flow values do not meet the amount specified, a process called balancing is used to adjust the airflow or water flow at a few or many grilles or coils by opening and closing the associated dampers or valves until each grille or coil has the correct amount of airflow or water flow. The overall process commonly referred to as testing and balancing, is time-consuming because dampers or coils are typically located above a ceiling, requiring a ladder for access. Additionally, the dampers, valves, coils, and grilles can be spread out over a large area requiring a lot of walking and movement of equipment. As a result, the individual or team testing and balancing a system must take an airflow or water flow measurement at a grille or coil, walk a distance and climb up a ladder to physically open or close a damper or valve and walk a distance to return to the grille or coil to measure the change in airflow or water flow. Also, if the system has multiple grilles or coils, each adjustment can vary the airflow or water flow at the other grilles or coils. Unpredictable airflow or water flow changes result in a time-consuming iterative process of adjusting dampers or valves, walking, taking grille or coil readings, climbing ladders, taking more readings, until each grille or coil reading is within an acceptable range of the design values. Testing and balancing a single HVAC system can take hours and commercial buildings can have hundreds of HVAC systems requiring test and balance.

### SUMMARY OF THE INVENTION

The testing and balancing of HVAC systems with manual dampers or valves is an iterative and time-consuming process when measuring the airflow or water flow at each grille or coil and adjusting the manual balancing damper or valve to within the specified tolerance of the design intent. The claimed invention allows the user to input the design airflow or water flow values into a computer data user interface for each grille or coil and the overall tolerance allowed above and below these design values. The system wirelessly communicates with airflow or water flow sensors measuring each actual grille airflow or coil water flow value and the accompanying temporary output motors attached to the damper or valve balance the grilles or coils in the system according to the design airflow or water flow values intelligently without further input from the user. Wireless communication and remote damper or valve movement solve the problem of manually needing to travel between dampers or valves to adjust dampers or valves by hand. Reducing travel time allows the user to perform other tasks that are beneficial to the project such as setting up the next system for testing. In addition, intelligent wireless balancing results in increased accuracy when balancing the overall system because it can adjust and iterate based on combinations of real-time data from multiple connected sensors at once; resulting in a balanced system that is more efficient.

### BRIEF DESCRIPTION OF THE DRAWINGS

The invention is understood best by referring to the following Detailed Description of Specific Embodiments in conjunction with the Drawings, of which:

FIG. 1A illustrates a schematic HVAC airflow and water flow system and major components of the intelligent balancing system.

FIG. 1B illustrates a tree schematic representation of network communication.

FIG. 1C illustrates a mesh schematic representation of network communication.

FIG. 2A illustrates the data user interface.

FIG. 2B illustrates the base node interface.

FIG. 3A illustrates the output node with a schematic diagram of a typical HVAC damper or valve and ductwork or pipe layout.

FIG. 3B illustrates an alternative view of the output node enclosure.

FIG. 3C illustrates an alternative view of the output node enclosure.

FIG. 4A illustrates the output node socket.

FIG. 4B illustrates an alternative view of the output node socket.

FIG. 5A illustrates the threaded shaft adapter.

FIG. 5B illustrates an alternative view of the threaded shaft adaptor.

FIG. 5C illustrates a cut away view of the threaded shaft adaptor.

FIG. 6A illustrates the square shaft adapter.

FIG. 6B illustrates an alternative view of the square shaft adapter.

FIG. 7 illustrates the output node strap used to hold an output node to a piece of ductwork or pipe.

FIG. 8 illustrates the flow node.

FIG. 9A illustrates the flow node attached to the magnetic capture hood.

FIG. 9B illustrates the magnetic capture hood.

FIG. 10 illustrates the system storage and transport system.

### DETAILED DESCRIPTION OF SPECIFIC EMBODIMENTS

Definitions. As used in this description and the accompanying claims, the following terms shall have the meanings indicated unless the context otherwise requires:

“HVAC system” means a system that provides heat, ventilation or air conditioning to a building or a portion of a building.

A “damper” is a device that controls the volume of airflow through ductwork. The device may be infinitely adjustable through manual human manipulation between two extreme states such as fully open or fully closed.

A “valve” is a device that controls the volume of water flow through a pipe. The device may be infinitely adjustable through manual human manipulation between two extreme states such as fully open or fully closed.

A “grille” is a device that is connected to ductwork and distributes a volume of air in specific directions.

A “coil” is a device that is connected to supply and return piping and transfers heat from one fluid to another.

A “design flow value” is a volumetric measurement of airflow or water flow an HVAC design engineer specifies that meets the needs of the indoor space.

A “base node” is an assembly used to communicate inputs and outputs from multiple nodes and display related outputs on a computer.

An “output node” is a compact wireless system that is used to open and close a damper or valve based on data feedback from other nodes, user feedback, or integrated sensors.

A “flow node” is a compact wireless system that is used to sense air pressure or water pressure and communicate the data to other nodes.

A “magnetic capture hood” is a device used to channel airflow from a grille over a set surface area so a flow node can sense air pressure differential.

Base Node Assembly

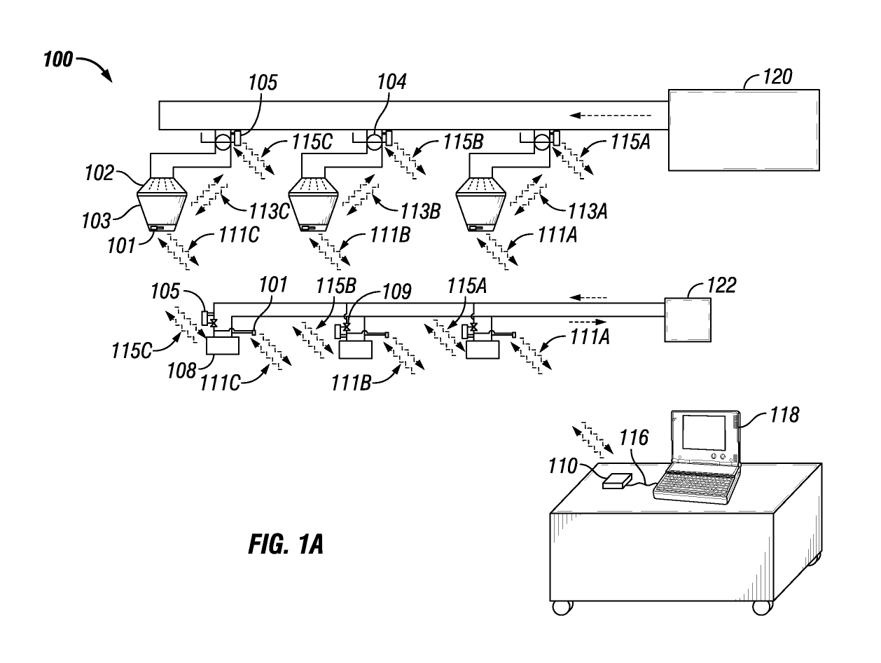

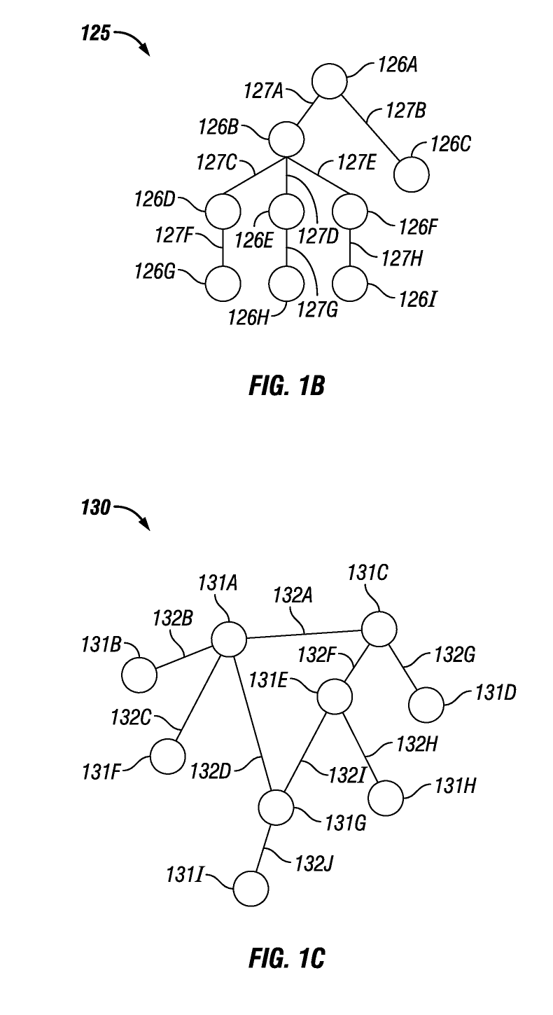

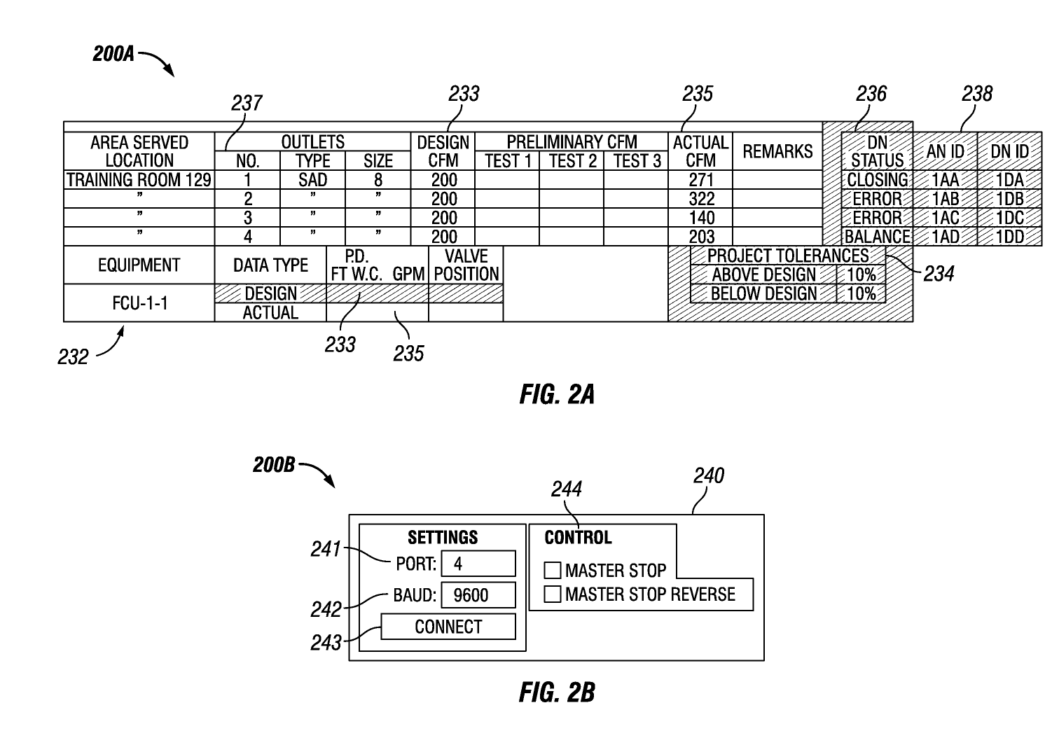

FIGS. 1A, 1B, and 1C illustrate an HVAC airflow or water flow system 100 and the communication between a flow node 101, output node 105, and a base node 110. The intelligent balancing system 100 is set up in a network configuration that allows many nodes to communicate over the distance of an HVAC system 120 or a water flow system 122. The base node 110 is the central hub of the system. The base node 110 is used to gather inputs and outputs from multiple sources such as the data user interface (seen in FIG. 2A), output nodes 105, and flow nodes 101. The base node 110 communicates inputs and outputs to their intended recipient. The output nodes can include control over a damper 104, or a control valve 109. In addition, there can be data or control aspects of a grille 102 or coil 108. The flow nodes can also include the magnetic capture hood 103, that can, but is not limited to, connecting via a magnetic connection to the grille 102.

The base node 110 wirelessly communicates with output nodes 105, and flow nodes 101 through a communication interface such as, but not limited to, a wireless transceiver, or a radio frequency (RF) transceiver, which operates at or near a frequency of 2.4 GHz, or another suitable frequency that provides robust transmission for a line of sight and entirely or partially obstructed transmission condition. The base node 110 also may contain, but is not limited to a microprocessor, microcontroller, controller, or processor, or other similar computing devices. The base node 110 utilizes in a preferred embodiment, but is not limited to, a wired universal serial bus (USB) connection 116, connected to, but is not limited to, a computer or computing device 118. The computer or computing device 118, as well as other microprocessors, microcontrollers, controllers, or processors in the present disclosure may, but are not limited to, representing one or more microprocessors. The microprocessors may be “general purpose” microprocessors, or a combination of general and special purpose microprocessors. The computing device may also be but is not limited to a phone, smartphone, tablet, laptop, personal computer, or other similar computing devices. Additional specialized processing resources such as graphics, multimedia, or mathematical processing capabilities, either in hardware or in software, may also be used as adjuncts or replacements for processors for certain processing tasks. In addition, the computing device 118 as well as other microprocessors, microcontrollers, controllers, or processors in the present disclosure may also have, but are not limited to, having or be connected to memory, random access memory (“RAM”), a hard disc, non-volatile memory, a communication bus, a user interface, display, keyboard, mouse, trackpad, roller ball, and/or a power supply. Alternatively, the base node 110 may communicate to a hand-held device such as a smartphone or tablet. The base node 110 receives and sends data to and from a data user interface (seen in FIG. 2A) on the computing device 118, tablet, or smartphone utilizing, but not limited to, a serial communication protocol.

### Wireless Node Network

The wireless node network is the wireless protocol that the intelligent wireless test and balance system utilizes for node communication. The communications sent from the base node 110 can include flow node communications 111A, 111B, or 111C (collectively 111), flow to output node communications 113A, 113B, or 113C (collectively 113), and output node communications 115A, 115B, or 115C (collectively 115). These communications can include, but are not limited to, control signals, environment data, or flow data. The network topology may be tree 125 or mesh 130 depending on the node addressing requirements. Within a tree network 125, the nodes 126A-126I (collectively 126) communicate node to node (e.g., 126A communicates to 126B and 126C) through connections 127A-1271 (collectively 127) to nodes 126 that are higher or lower in the tree hierarchy. However, in a mesh network 130, the nodes 131A-131I (collectively 131) communicate node to node (e.g., 131A communicates to 131B, 131F, 131G, and 131C) through connections 132A-132J (collectively 132) to nodes 131 across the network, but not limited to those in direct communication with the node allowing data to be relayed across the network. Each node in the network has a unique network address that allows for the identification of the node type, such as but not limited to output or flow nodes, and assignment of the node to a grille 102 number or coil 108 numbers. The base node 110 coordinates all incoming and outgoing messages, automatically, allowing the node network illustrated in FIG. 1 to interconnect itself, and for data to flow to and from nodes seamlessly.

### Data User Interface

In FIG. 2A, the base node 110 shown in FIG. 1A communicates with the data user interface 232, initially to acquire and store basic design data, such as, but not limited to, design flow 233 values, and project tolerance 234 percentages above and below design flow 233 values, an illustrative example of which is seen as 200A. The data user interface 232 allows the user to provide initial system data, and to monitor actual node data and statuses in real time.

The base node 110 (shown in FIG. 1A) sends and receives different types of data messages from other nodes automatically. When the base node receives a message, the base node checks to see if the node it received the message from is on the active node list and if it is not the base node adds the node to the list. A “T” message is received from a flow node 101 (shown in FIG. 1A) and contains the actual flow value 235 that corresponds to the damper or valve address of the flow node. An “S” message is received from an output node 105 (shown in FIG. 1A) and contains the output node status 236, such as opening, closing, or balanced. An “R” message is received from an output node and contains a request for design flow value 233, resulting in a “D” message being sent back in response that includes the design flow value 233.

A computer or base node computing device 118 (shown in FIG. 1A) is utilized to display a data user interface 232 that contains one or more matrices containing airflow or water flow data such as HVAC design flow values 233, actual flow values 235, and output node status 236. A user may at an earlier time populate the data user interface 232 with individual HVAC system data such as area served location, sequence number 237, neck size, volumetric airflow rates, volumetric water flow rates, and project tolerances 234 above and below the specified volumetric flow rate allowed by design. Each matrix row is used to correlate input and output data with a grille or coil sequence number 237 and output node 105 and flow node 101 pair sequence. Additional data may be available to the user, such as output node status 236, and unique node identification code 238. The data user interface 232 is not limited to running on the base node computing device 118 (seen in FIG. 1A) and may exist on a smart device such as or similar to an Android or iOS device, of which may be handheld, worn on the body, or utilize a heads-up display.

### Base Node Interface

In FIG. 2B an illustrative example (200B) of the base node interface is provided. The base node interface 240 allows the user to connect the base node 110 (shown in FIG. 1) and the data user interface 232 (shown in FIG. 2A) and to send master commands.

The base node interface 240 allows the user to specify the initial communication settings such as, but not limited to, serial port channels 241, baud rates 242 at which a channel transfers data over the channel unique to the base node 110 (shown in FIG. 1A). The user can use an interface button 243 to connect or disconnect the base node 110 (shown in FIG. 1A), as well as send master control commands 244. The base node 110 (shown in FIG. 1A) interface 240 can be, but is not limited to, a plug-in for Microsoft Excel, or other spreadsheet, mathematical, or programmable software package, that can allow for direct integration with the data user interface 232. Additionally, the base node interface 240 is not limited to running on the computing device 118 (seen in FIG. 1A) and may exist on a smart device such as or similar to an Android or iOS device, of which may be handheld, worn on the body, or utilize a heads-up display.

### Output Node Assembly

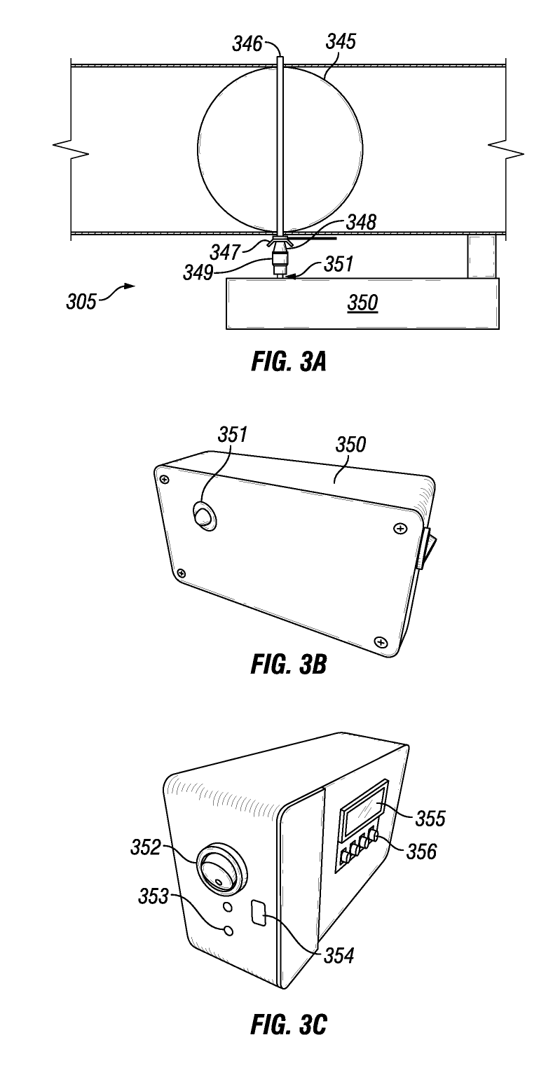

In FIGS. 3A, 3B, and 3C, the output node assembly is illustrated. The output node assembly 305 is a compact wireless system that is used to open and close a damper 104 or valve 109 (shown in FIG. 1A) based on, but not limited to, data feedback from other nodes, user feedback, or integrated sensors.

The output node 305 utilizes an output node wireless transceiver such as, but not limited to, a radio frequency transceiver similar to that of the base node 110 (shown in FIG. 1A) that is connected to the output computing device. Other wireless transmission standards can also be utilized, such as but not limited to Wi-Fi, Bluetooth, ZigBee, Near Field Communication (“NFC”), 5 GHz, and/or cellular communications system, such as, but not limited to, LTE. Utilizing the RF transceiver, the output node 305 may include, but is not limited to, the ability to transmit or receive data from other output nodes 305, flow nodes 101, and the base node 110 (shown in FIG. 1A) simultaneously or at once. Data transmitted or received may be, but is not limited to, a design flow value 233, actual flow 235 value, or output node status 236 (shown in FIG. 2A). Any data transmitted or received may be stored on a data storage medium such as, but not limited to memory, a memory card, or a hard disc drive.

An electric gear motor or similar motor (not shown) with characteristics such as, but not limited to low revolutions per minute and high torque to size ratio is, placed within the enclosure 350, and used to rotate the damper or valve shaft 346. An electric motor control circuit can, but is not limited to, varying speed, duration, and direction of rotation through varying techniques such as, but not limited to, pulse width modulation. In a preferred embodiment, a motor control circuit is placed within the enclosure 350, and is connected to a processor, controller, microprocessor, or micro-controller circuit such as, but not limited to, the same processor, controller, microprocessor, or micro-controller circuit or output computing device that operates the wireless or wired system.

The torque of the electric motor can be measured by, but is not limited to, a current sensing circuit as current draw is related to the amount of torque the electric motor is applying to the valve or damper shaft 346. In a preferred embodiment of the present disclosure, the output node 305 utilizes a current circuit so that if damper or valve blades 345 are bound, stuck, or are constrained by rotation stops they will not break as a result of applying too much torque. A maximum current threshold can be set, via the base node computing device, output node computing device, processor, controller, microprocessor, or micro-controller circuit, or through a message from the data user interface (shown in FIG. 2A) for the electric motor not to exceed the threshold. If the motor exceeds the threshold, it is stopped, preventing any damage from occurring to the damper or valve and the output node 305 can, for example but is not limited to, communicating an output node status 236 (seen in FIG. 2A) error back to the data user interface 232.

The output node 305 uses a rigid compact enclosure 350 that is designed to house components of the output node 305 while allowing the electric motor shaft 351 to pass through the enclosure 350. The enclosure 350 is made of a durable material, such as, but not limited to, acrylonitrile butadiene styrene (ABS) plastic, providing durability, impact resistance, and minimal impact on 2.4 GHz radio waves, other materials of manufacture could include but are not limited to wood, metal, plastics, carbon fiber, polyvinyl chloride, or other composite materials. The enclosure 350 may also include, but is not limited to having, an on and off power switch 352, viewing accesses for light emitting diode (LED) indicators 353, and/or a charging port 354. The user may interface with the output node 305 through an incorporated liquid crystal display (LCD) 355 and directional buttons 356, allowing the user to visually monitor the status of the output node 305, as well as provide node specific inputs as needed, such as, but not limited to, output node identification 238. The LED indicators, charging port, battery, display, or buttons may be connected to the output node computing device.

The output node 305 can contain, but is not limited to, a rechargeable lithium-ion battery or other power source that is sized to deliver the required energy to power the output node 305 for one or more typical days of testing and balancing. Additionally, other power sources could be alternative power sources such as, but not limited to, Alternative Current (“AC”), Direct Current (“DC”), solar power, wind power, or power generated by moving water. The output node 305 contains a circuit designed to allow the user to recharge the battery or connect other power sources utilizing, but not limited to, a USB cable and the charging port 354. LED indicators 353 are used, but not limited to, communicating battery level or charging status, and a “low battery” status can be made available to the user on, but not limited to, the LCD screen 355 or remotely on the data user interface 232 (shown in FIG. 2A).

When powered on, the output node 305 is designed to monitor specific start-up criteria before the electric motor is engaged. The output node 305 must initially receive at least one of, but not limited to: (a) a valid design flow value 233 from the base node 110, (b) a valid actual flow value 235 from the paired flow node 101, and/or (c) have not received a master stop command 244 from the base node 110. Once the initial startup criteria has been met the output node 305 transitions into a setup phase, and the output node 305 stores the actual flow value 235 at that moment as a baseline value before rotating the damper or valve shaft 346 with the output node 305 electric motor. The electric motor is engaged to rotate the damper or valve blade 345 in a known direction, such as but not limited to a clockwise rotation, while the output node 305 monitors the resulting change in actual flow value 235 from the paired child flow node 101. While rotating, the output node 305 evaluates the absolute value of the difference between the current flow, and the initial baseline flow against a set difference amount that corresponds with the consistent correlation between rotational direction and flow values corresponding to the damper or valve blade 345 opening or closing. If the difference value is met or exceeded, the signed difference value is used to assign a clockwise or counterclockwise rotation, a positive difference is related to opening, and a negative difference is related to closing.

During the setup phase, while the electric motor is rotating, the motor current is monitored. A current value greater than a set maximum threshold stops the electric motor from rotating in its present direction and results in beginning the setup phase over in the opposite direction. If the maximum threshold current is exceeded again after, having switched directions, the motor stops and an error status is sent to display on the data user interface 232 (shown in FIG. 2A). The output node 305 completes the setup phase once the rotation is assigned or the setup phase exceeds a preset maximum duration of time, which if exceeded, stops rotation and assigns rotation based on the difference value at that point.

Once the startup and setup phases are complete, the output node 305 operates in the balancing phase. The balancing phase utilizes the set project tolerance 234 percentages above and below design flow value 233 as the target range, which represents a balanced state. Balanced state is the condition when the current actual flow 235 value from the paired flow node 101 is within the range of the set project tolerances 234 percentages. Based on the actual flow 235 value from a paired flow node 101, the paired output node motor is energized and rotated in the direction that results in the actual flow 235 value converging on the balanced state range. The output node 305 stores a new time value in milliseconds each time it receives a new actual flow 235 value from the paired flow node 101 and each time the output motor energizes, the output node 305 stores a time value in milliseconds, but is not limited to storing a time value milliseconds, as other time intervals such as microsecond or nanoseconds may also be used. The output node 305 subtracts the two stored time values to monitor the electric motor run time between receiving actual flow 235 values. A set maximum duration runtime threshold is used to compare to the runtime duration of the electric motor. If the motor exceeds the runtime duration, the motor stops and the output node 305, sends a time-out output node status 236 back to the base node 110 for display on the data user interface 232. Output node 305 constantly monitors the motor current to compare to a preset maximum current threshold during the balance phase. If the motor exceeds the threshold, the output motor stops, and an error output node status 236 is sent to the base node 110 to display on the data user interface 232. Master commands 244 sent from the base node 110 can control output nodes 305 and a master stop command can disable motor movement regardless of flow node 101 input. The output node 305 cannot move until the output node 305 receives a command removing the master stop command or the output node 305 power is cycled off and on.

Output Motor Socket

The output motor socket 349 adapts between the output motor shaft 351 and the shaft adapter 348. The shaft adapter 348 can then nest within the outward angled wings of a standardly installed wing nut 347 or to allow tool access to the damper or valve shaft 346. The output motor transmits rotational force through the output motor shaft 351, traditionally the output motor shaft will be, but not limited to, a round output shaft that has a section notched to provide a key slot.

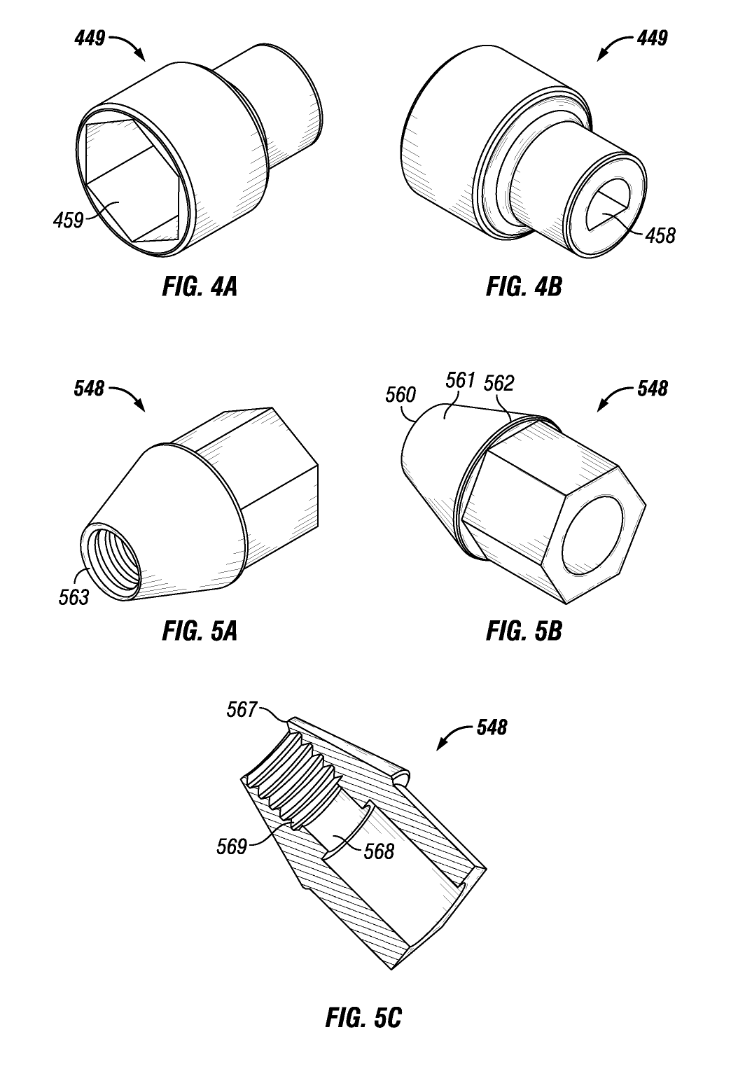

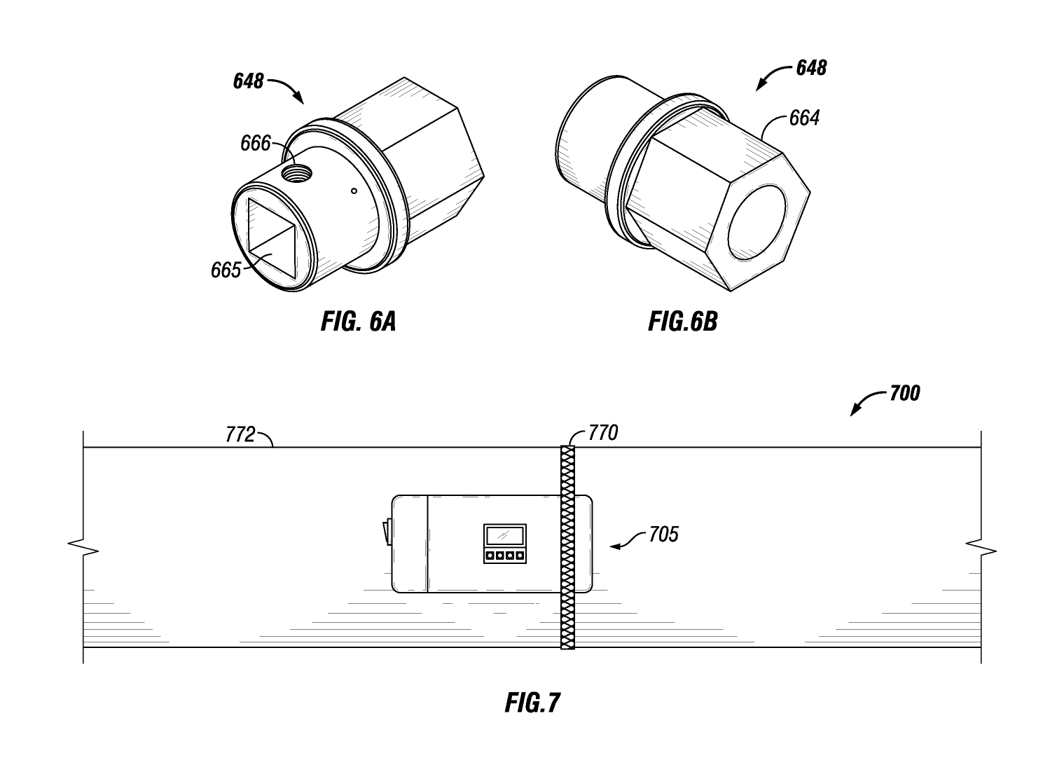

FIGS. 4A and 4B illustrate alternative views of the output motor socket 449. The output motor socket 449 has a design where one end has a round opening with a matching socket key 458 to allow the output motor socket 449 to be press-fitted by hand onto the output motor shaft (shown in FIG. 3A). The opposite end of the output motor socket 449 has a mechanical socket 459 opening allowing the shaft adapter (shown in FIGS. 3A and 5A-5C) to temporarily mate inside the mechanical socket 459 to translate rotational movement. The mechanical socket 459 design allows for the output node 105 to have multiple mounting positions without rotating the output node motor or the damper or valve shaft positions.

### Shaft Adapter

FIGS. 5A, 5B, 5C, 6A, and 6B illustrate the shaft adaptor 548/648. The shaft adapter 548/648 adapts between the damper or valve shaft or output control (shown in FIG. 3A) and the output motor socket (shown in FIGS. 3A, 4A, and 4B).

The HVAC industry utilizes multiple damper and valve shaft end types, with the majority including an end that is threaded, notched, round, or square. Multiple versions of the shaft adapter 548/648 have been designed to match the majority of the damper shaft types, such as, but not limited to, threaded, notched, round, or square designs. A shaft adapter 548/648 is selected to match the specific damper or valve shaft type.

A threaded shaft adapter 548 may contain similar threads 563 as the damper or valve shaft end allowing the threaded or round shaft adapter 548 to thread or slide onto the damper or valve shaft end by hand or by utilizing a hand tool or power tool The duct or piping facing side of the threaded shaft adapter may be physically shaped in a tapered design 561 with the smallest diameter 560 beginning closest to duct or pipe and concentric with the damper or valve shaft and increasing in diameter as the distance away from the duct or pipe increases to the largest diameter 562. The threaded or round shaft adapter 548 taper 561 allows it to nest within the outward angled wings of a standardly installed wing nut (shown in FIG. 3A) or to allow tool access to the damper or valve shaft. The internal threads or smooth internal surface 563 of the shaft adapter 548 may span from the end of the shaft adapter 548 closest to the duct or pipe 567 throughout its entire internal open diameter, or it may be limited to a length away from the ductwork 569 that allows for sufficient and sustainable engagement of the damper shaft end threading or round shaft end. This length should engage enough threads or shaft as to prevent damage or stripping of threads under expected working torques and based on the output node 105 assembly and damper shaft material composition. Optionally, following the end of the open inner diameter threading or smooth surface 569 furthest from the ductwork or pipe may be an inner diameter that is not threaded 568, for a distance that allows the adapter to lock onto the damper or valve shaft in a similar behavior as a self-locking nut. The square shaft adapter 648 contains a square opening 665 that is designed to accommodate square, notched, or round damper or valve shaft ends. The shaft adapter 648 may include, but is not limited to, a threaded hole 666 that accommodates a setscrew (not shown) to prevent shaft rotation. The threaded shaft adapter 548 and square shaft adapter 648 may include a design that accommodates, but is not limited to, other damper or valve shafts of varying sizes, thread counts, or shapes.

The threaded or square shaft adapter end furthest from the ductwork or piping may have a shape and size similar to a standard fastening nut 664. This design allows the user to use readily available mechanic sockets fitted to a hand or power tool to tighten or loosen the shaft adapter 548/648 onto the damper or valve shaft end. Additionally, this design allows for the corresponding output motor socket (seen in FIGS. 3A, 4A, and 4B) to temporarily mate to the shaft adapter 548/648. Various materials such as but not limited to plastic, wood, carbon fiber, metal, composite material, or paper can be used to construct either shaft adapter 548/648. Optionally, the unit cost of the shaft adapter 548/648 may be low enough to allow for the shaft adapter 548/648 to remain on the damper or valve shaft end as a time-saving measure and to prevent disturbing the balanced damper or valve blade position.

### Output Node Strap

In FIG. 7, the output node is illustrated in a hanging position 700 by an output node strap. The output node strap 770 temporarily secures the output node 705 to the ductwork or pipe 772 to counter the rotational force from the output node electric motor or to maintain a relative position of the output node electric motor (not shown) and a damper or valve shaft (not shown).

The output node 705 assembly utilizes an output node strap 770 that provides a temporary connection to the ductwork or pipe 772 encompassing the damper or valve blade (not shown). An output node strap 770 may be used to counter the rotational force applied to the damper or valve shaft (not shown) by the output node 705 or to maintain a relative position of the output node and the damper or valve shaft. The output node strap 770 has, but is not limited to, a fabric “hook and loop” (Velcro) fastener construction and fully encircles the ductwork or pipe 772 parallel with the damper or valve blade assemblies, providing a fixed point to prevent rotation. Other materials such as, but not limited to, rope, string, magnet, or similar fastening material may be used to provide a temporary nondestructive means of creating a fixed point to prevent the output node 705 from rotating. The output node strap 770 may include the ability to be quickly removed or attached to the output node 705.

### Flow Node Assembly

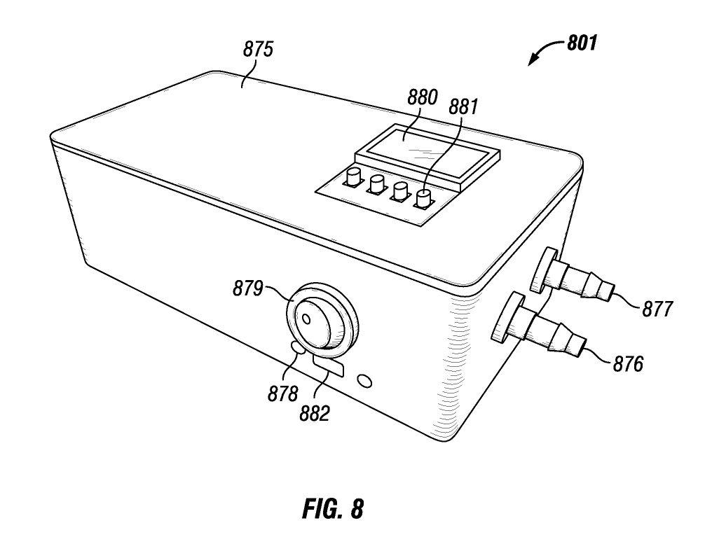

FIG. 8 provides an illustrative example of the flow node assembly 801. The flow node 801 is a compact wireless system that is used to sense and communicate the differential pressure of airflow through the magnetic capture hood (not shown) or water flow rates through a coil (not shown). A flow node 801 can be configured for airflow measurement and is represented by airflow node and/enclosure 875.

The airflow node 875 utilizes but is not limited to, a compact and ultra-low range differential pressure sensor (not shown) with high accuracy and precision, especially near zero pressure and enclosed within the airflow node enclosure 875. The sensor has, but is not limited to, a digital output and communicates through, but is not limited to, the inter-integrated circuit (I2C) protocol, and the sensor incorporates, but is not limited to the incorporation of, calibration, temperature compensation, and signal linearization into the data output. The sensor measures differential pressure by a thermal sensor element using flow-through technology. Compared with membrane-based sensors, typically used by most pressure sensors for HVAC test and balance measurement, the flow-through technology does not require constant recalibration with air valves and experiences no offset drift. The sensor used contains, but is not limited to, a thermal mass flow sensor element, amplifier, analog to digital (A/D) converter, EEPROM memory, digital signal processing circuitry and interface. In addition, the sensor measurement range is specifically matched to typical max actual airflow value the sensor is intended to measure from a grille (not shown).

A flow node 801 designed for measurement of water flow can utilize a compact differential pressure sensor rated for liquid measurement with high accuracy and precision. The sensor measurement range is specifically matched to typical max actual water flow value the sensor is intended to measure from a coil (not shown).

The flow node 801 uses a small microprocessor, but is not limited to a flow node computing device, micro-controller, processor, or controller as well, to receive the digital output of a flow node 801 sensor. The microprocessor or flow node processor or flow node computing device is used to store multiple readings and average the result, on a data storage medium such as, but not limited to memory, a memory card, or a hard disc drive. The flow node 801 converts the averaged result from pressure units, typically inches water column for air or pounds per square inch for water, to feet per minute (FPM) for air and gallons per minute (GPM) for water with industry standard conversion formulas. For air measurement, further converting FPM to a cubic foot per minute (CFM) result is done by multiplying the FPM result by the unobstructed measurement surface area perpendicular to the flow inside of the magnetic capture hood (not shown). After conversion, the flow node 801 reading units are the same as the design flow (seen in FIG. 2A) value specified by the design engineer.

The flow node 801 utilizes a flow node wireless transceiver such as a radio frequency transceiver similar to that of the base node (seen in FIG. 1A). The flow node transceiver may be connected to the flow node computing device. Utilizing the RF transceiver, the flow node 801 may include, but is not limited to, the ability to transmit data from other flow nodes 801, output nodes (seen in FIG. 1A), and the base node simultaneously or at once. Data transmitted or received may be, but is not limited to, the form of actual flow values, design flow values, and master control commands (shown in FIGS. 2A and 2B).

The flow node 801 uses a rigid compact enclosure 875 which is designed to house all flow node 801 components while allowing the sensor positive 876 and negative pressure ports 877 to pass through the enclosure 875. The enclosure 875 is made of durable material, such as, but not limited to, acrylonitrile butadiene styrene (ABS) plastic, providing durability, impact resistance, and minimal impact on 2.4 GHz radio waves, other materials of manufacture could include but are not limited to, wood, metal, plastics, carbon fiber, polyvinyl chloride, or other composite materials. The enclosure 875 may have, but is not limited to having, an on and off power switch 879, viewing access for light emitting diode (LED) indicators 878, and a charging port 882.

The user may interface with the flow node 801 through, but not limited to, an incorporated liquid crystal display (LCD) 880 and directional buttons 881. The LCD 880 and directional buttons 881 allow the user to visually monitor the actual flow (shown in FIG. 2A) sensed by the flow node 801, as well as provide node specific inputs as needed, such as a unique node identification code (shown in FIGS. 2A and 2B).

The flow node 801 can contain, but is not limited to, a rechargeable lithium-ion battery that is sized to provide the required energy to power the flow node 801 for one or more typical days of testing and balancing. Additionally, other power sources could be alternative power sources such as, but not limited to, Alternative Current (“AC”), Direct Current (“DC”), solar power, wind power, or power generated by moving water. The flow node 801 can contain, but is not limited to, a circuit designed to allow the user to recharge the battery utilizing a USB cable and the charging port 882. LED indicators 878 are used, but not limited to the uses, of communicating the battery level or charging status. In addition, a “low battery” status can be made available to the user on, but not limited to, the LCD 880 screen or remotely on the data user interface (shown in FIG. 2A). The flow node computing device may be connected to the battery, LED indicators, charging port, display, or buttons of the flow node.

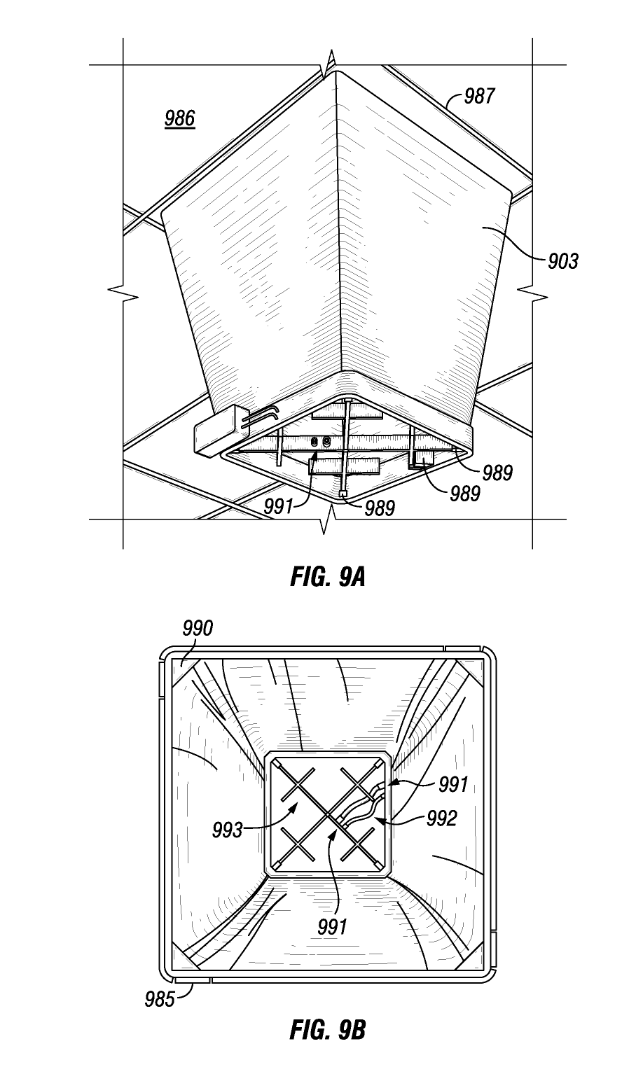

The flow node 801 processes pressure readings and sends and receives different types of data messages from other nodes automatically. An “N” message is received from the base node (shown in FIG. 1A) and contains a list of active nodes. A “T” message is sent from the flow node 801 to the base node and its corresponding output node (shown in FIG. 1A) and contains the actual flow value. The flow node 801 specific to airflow measurement secures onto the magnetic capture hood (not shown) in a location that allows for the pressure ports 876/877 to be attached (shown in FIG. 9B at 991) to the magnetic capture hood.

### Magnetic Capture Hood

The magnetic capture hood 903 illustrated in FIGS. 9A and 9B, is used to gather airflow from a grille (shown FIG. 1A) for measurement, or alternatively act as a flow detection module. The flow detection module 993 may also contain the flow node sensor. The flow detection module 993 may also include alternative designs such as circle, square, triangle or other polygon shapes. The pressure ports seen in FIG. 8 as 876 and 877 can be connected to the flow detection module or flow node sensor through ports 991 or hoses 992. It would be understood that in alternative embodiments of the present disclosure the port or hoses maybe utilized in tandem or individually based upon the design of the flow node, flow node sensor or flow detection module. The magnetic capture hood 903 is customized to allow a single user to deploy multiple magnetic capture hoods 903 and utilize them simultaneously during the testing and balancing process. The magnetic capture hood 903 is also sized to hold the flow detection module 993.

Airflow capture hoods similar to those produced by Shortridge Instruments, Inc. or Evergreen Telemetry are commonly utilized throughout the testing and balancing industry. Most capture hoods used in the industry are large and are held against a grille by hand or with a pole from the bottom, requiring a rigid internal structure to hold them open during testing. The size constraint leads to difficulties in areas such as transport, use in tight spaces and increased setup time.

The magnetic capture hood 903 utilizes magnets 985 at the top of the frame 990 in the area that comes in contact with the ceiling grid 987. A vast majority of ceiling grids 987 are ferrous metal allowing the magnet 985 to stick to the ceiling grid 987 surfaces. The magnetic capture hood 903 suspends itself from the ceiling 986 with the magnets 985, and the weight of the bottom 989 of the magnetic capture hood 903 holds it open. The use of gravity allows for the removal of internal structures from the magnetic capture hood 903.

The use of magnets 985 and gravity to hold and extend the magnetic capture hood 903 provide a unique advantage, allowing one user to quickly deploy multiple magnetic capture hoods 903 simultaneously during the testing and balancing process.

### System Storage and Transport

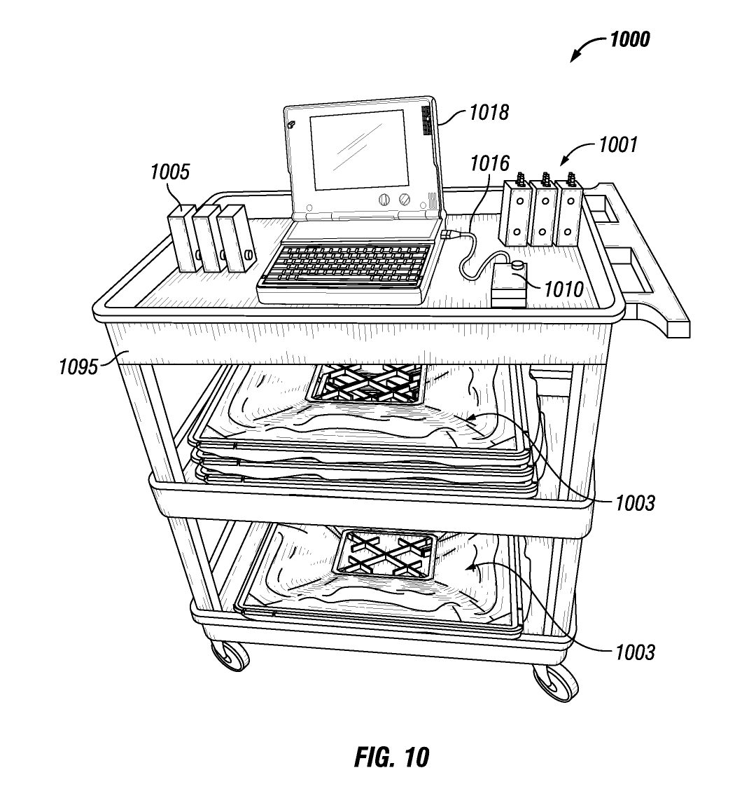

FIG. 10, illustrates the utility cart 1095 is used to store, transport, and charge the intelligent wireless test and balance system 1000.

The intelligent wireless test and balance system is stored and transported on the utility cart 1095 illustrated in FIG. 10. The utility cart 1095 stores many nodes, such as but not limited to, flow nodes 1001 or output noes 1005 and can serve as a charging station with integrated battery power, multiple charging cords or wireless charging capabilities. The utility cart 1095 also stores multiple magnetic capture hoods 1003 due to their collapsible design. Additionally, the utility cart 1095 can also provide a user a station to work from that includes a computer 1018, connection cord 1016 and base node 1010 to communicate with all the various nodes, such as but not limited to, flow nodes 1001 or output noes 1005 that are deployed. The utility cart may be self-powered including the ability to transport the user as well as the intelligent wireless test and balance system.

### Example Installation and Use

The installation process begins with the user selecting the HVAC system that needs to be tested and balanced. The user moves their utility cart, which contains the balancing system components described above, to the general area of the HVAC system. The user utilizes their personal computer to open the data user interface unique to the system chosen and opens and connects the base node interface. The user utilizes prepared mechanical drawings showing a general location and number of each grille or coil to become familiar with the system. The user locates the sequence number one grille or coil and positions their ladder to reach the grille or coil. Specific to airflow measurement, the user lifts the magnetic capture, and one side of the magnetic capture hood is aligned, and the magnets are engaged. The other end of the capture hood is swung into place to engage the other end with magnets. The user verifies proper magnet engagement and alignment of the capture hood with the outer edges of the grille.

Specific to water flow, the user connects the positive and negative sensor ports to the supply and return pipes. The user energizes the accompanying flow node, which is typically kept attached to the capture hood if measuring airflow, and verifies it corresponds with the grille or coil one numbering. The user locates the damper or valve above the ceiling for grille or coil one using a ladder, loosens any damper or valve shaft fasteners, and rotates the damper or valve shaft from closed to open verifying it has no obstructions. The user installs a threaded or square shaft adapter depending on the damper or valve shaft type. The user then temporarily mates the shaft adapter with the output motor socket on the output node in a position that allows the output node strap to encircle the ductwork or pipe next to the damper or valve. The output node strap is initially fastened to the output node and then is wrapped around the ductwork or pipe tightly and secured onto itself. A variable spacer may be used between the ductwork or pipe and the output node enclosure to ensure the output node enclosure is parallel with the ductwork or pipe when tightened with the output node strap. The spacer prevents the damper or valve shaft from binding or experiencing unnecessary stress due to misalignment. The user energizes the output node assembly and verifies it corresponds with the grille or coil one numbering. The user continues the installation process for all grille or coils contained in the HVAC system being tested and balanced, working from numbered grille or coil one to the highest grille or coil number in the system.

Once all nodes are installed, the user returns to their personal computer to monitor the live data and statuses from the active nodes. The user may also send master commands, such as an output node “fully open” command, to help facilitate the required testing and balancing procedure unique to the type of systems such as proportional balancing or HVAC subsystem calibration procedures. In addition, the user may respond to a node status, such as a “stuck” status from an output node by physically fixing the issue. Once the user is satisfied with the system balance, they send a master stop command to disable all output nodes from moving, capturing the balanced state while the user removes the nodes. Before removing each output node, the user tightens the original locking nut and permanently marks the balanced damper or valve shaft position. Depending on the project, the user may recover the shaft adapter, or it may be left on for future balancing or other use. The installation and use steps above were described based on a single user; however, most of the tasks can be simultaneously completed and efficiently separated for multiple user teams.

### Example Advantages

The intelligent wireless test and balance system contains multiple advantages over the traditional test and balance method resulting in greater efficiency, time savings, and a reduced workforce.

When the user opens the data user interface and connects the base node interface, the design data is instantly available and sent to the output nodes as they are joining the network. In addition, as soon as the first flow and output node pair is installed and energized the system can begin to seek the balanced state. Energizing more node pairs results in the other energized pairs actively adjusting their flow as the new node pair seeks the balanced state. The system progresses further towards a fully balanced state as the user adds each node, at or faster than the rate, the user is installing the node pairs. As a result, when the user energizes the last node pair, the entire system can achieve a fully balanced state in as little as seconds or a few minutes. The combined time required to install the node pairs and for the system to reach a fully balanced state can be significantly less when compared to the traditional method.

The user balancing the system may require fully open dampers or valves and the actual airflow or water flow to be added up to confirm the required total design flow is available. Traditionally, the user goes to each damper or valve and manually opens it and measures each grille or coil output once all the dampers or valves are open. This method is labor intensive and requires relatively significant time to complete. The intelligent test and balance system allows the user to command all the dampers or valves to open with a single click fully and to capture the total actual flow simultaneously. As a result, the user can confirm all the required total design flow is available in a fraction of the time with no movement required.

If the total design flow is not available the user may employ a proportional balancing technique where the user divides the total actual flow by the total design flow resulting in a correction factor. Traditionally, identifying that proportional balancing is needed requires at least one round of manual flow measurement of all the grilles or coils and multiple rounds of testing incorporating the calculated correction factor. In contrast, the intelligent test and balance system allows the user to open all dampers or valves, calculate the correction factor, send new corrected design flow values to output nodes, and begin balancing the system with the proportional values with a few clicks in a fraction of the time.

The user being able to open and close all the system dampers and valves from a single location at once and receiving the real-time actual flow values for all system outlets provides a reduction in movement, time, and workforce required to balance an HVAC system. In addition, the precision control, feedback loop, and quick iterative process allow the HVAC system to be balanced closer to design resulting in increased energy efficiency gains and comfort for building occupants.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary of the Invention” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

I claim:

1. A flow balancing system comprising:
a base node having a communication interface, wherein the communication interface is coupled to a flow node and an output node;
wherein the flow node further comprising a flow detection module extending from the flow node, wherein the flow detection module comprises a differential pressure sensor for capturing pressure data; and
wherein the output node comprises an output motor for controlling an output control and an adaptor.

2. The flow balancing system of claim 1, wherein the communication interface further comprising a wireless transceiver for wireless communication.

3. The flow balancing system of claim 1, wherein the base node is connected to a base node computing device configured to run a data user interface, and a base node interface.

4. The flow balancing system of claim 1, wherein the base node is in a wired connection with a base node computing device.

5. The flow balancing system of claim 1, wherein the base node is wirelessly connected to a phone, a smartphone, or a tablet.

6. The flow balancing system of claim 1, wherein the flow node further comprising a flow node computing device.

7. The flow balancing system of claim 1, wherein the flow node further comprising a flow node wireless transceiver.

8. The flow balancing system of claim 1, wherein the differential pressure sensor, is a thermal mass flow sensor.

9. The flow balancing system of claim 1, wherein the flow detection module further comprises a capture hood configured and sized to receive a grille.

10. The flow balancing system of claim 1, wherein the flow node is configured to transmit a set of pressure flow readings, and receive an actual flow value from the base node.

11. The flow balancing system of claim 9, wherein the capture hood further comprises magnets for connecting the capture hood to metallic or magnetic surfaces of the grille.

12. The flow balancing system of claim 1, wherein the output node further comprising an output computing device.

13. The flow balancing system of claim 1, wherein the output node further comprising an output node wireless transceiver.

14. The flow balancing system of claim 1, wherein the output node further comprising a output motor current detection circuit.

15. The flow balancing system of claim 1, wherein the output node is configured to transmit a rotational status of the output control, and receive an actual flow value, or a design flow data from the base node.

16. The flow balancing system of claim 1, wherein the output node further comprising an output node strap allowing for the attachment of the output node to a ductwork or a pipe.

17. The flow balancing system of claim 1, wherein the adaptor further comprising an output motor socket and a shaft adaptor.

18. The flow balancing system of claim 17, wherein the shaft adaptor is a threaded shaft adaptor.

19. A flow balancing system comprising:
a base node having a communication interface, wherein the communication interface is wirelessly coupled to a flow node and an output node, and directly coupled to a base node computing device;
wherein the flow node further comprising a flow detection module extending from the flow node and a flow node computing device connected to the flow detection module, wherein the flow detection module comprises a differential pressure sensor for capturing pressure data and a capture hood;
wherein the flow node further comprising a flow node wireless transceiver;
wherein the flow node is configured to transmit a set of pressure flow readings, and receive an actual flow value from the base node;
wherein the output node comprises an output computing device and an output motor for controlling a shaft;
wherein the output node further comprising an output node wireless transceiver;
wherein the output node is configured to transmit a rotational status of the output control, and receive an actual flow value, or a design flow data from the base node; and
wherein the damper shaft is connected to the output motor by an output motor socket and a shaft adaptor.

20. A flow balancing system comprising:
a base node having a communication interface, wherein the communication interface is wirelessly coupled to a flow node and an output node, and directly coupled to a base node computing device;
wherein the flow node further comprising a flow detection module extending from the flow node and a flow node computing device connected to the flow detection module, wherein the flow detection module comprises a differential pressure sensor for capturing pressure data;
wherein the flow node further comprising a flow node wireless transceiver;
wherein the flow node is configured to transmit a set of pressure flow readings, and receive an actual flow value from the base node;
wherein the output node comprises an output computing device and an output motor for controlling a valve shaft;
wherein the output node further comprising an output node wireless transceiver;
wherein the output node is configured to transmit a rotational status of the output control, and receive an actual flow value, or a design flow data from the base node; and
wherein the valve shaft is connected to the output motor by an output motor socket and a shaft adaptor.
